(19) United States
(12) Patent Application Publication
(10) Pub. No.: US 2026/0258767 A1
(43) Pub. Date: Sep. 3, 2026

(54) Piston and Internal Combustion Engine

(71) Applicant: KS Kolbenschmidt GmbH, Neckarsulm (DE)

(72) Inventor: Klaus Lormes, Bad Rappenau (DE)

(21) Appl. No.: 19/163,481

(22) PCT Filed: Mar. 6, 2024
(86) PCT No.: PCT/EP2024/055911

§ 371 Date: Sep. 9, 2025

(30) Foreign Application Priority Data
Mar. 15, 2023 (DE) 10 2023 106 531.9

(51) Int. Cl. F02F 3/26; F02B 43/04; F02B 43/10; F02F 3/16

(52) U.S. Cl. CPC F02F 3/26; F02B 43/04; F02B 43/10; F02F 3/16

(57) ABSTRACT

A piston (8A, 8B) for a hydrogen-powered internal combustion engine (7) including a piston head (11), a piston skirt (10) connected to the piston head (11), and a combustion bowl (24) provided on the piston head (11). The piston (8A, 8B) has a piston diameter (32) that can be measured on the piston skirt (10), wherein the combustion bowl (24) has a minimum combustion bowl volume (29) amount of 2.9674 times the amount of the piston diameter (32) minus a value of −220.68, and wherein the combustion bowl (24) has a maximum combustion bowl volume (29) amount of 4.1893 times the amount of the piston diameter (32) minus a value of −311.55. Also disclosed is a hydrogen-powered internal combustion engine including the piston.

### CROSS-REFERENCE TO RELATED APPLICATIONS

This application is filed pursuant to 35 U.S.C. § 371 claiming priority benefit to PCT/EP 2024/055911 filed Mar. 6, 2024, which claims priority benefit to German Patent Application 102023106531.9 filed Mar. 15, 2023, the contents of both applications are incorporated herein by reference in the entirety for all purposes.

### TECHNICAL FIELD

The present invention relates to a piston for a hydrogen-powered internal combustion engine and a hydrogen-powered internal combustion engine with such a piston.

### BACKGROUND

In order to prevent the emission of carbon dioxide and hydrocarbons in internal combustion engines, there are approaches to operating internal combustion engines with gaseous hydrogen. In this case, the internal combustion engine burns a hydrogen/air mixture. However, according to internal findings, this can lead to the problem of undesirable knocking combustion due to the high flammability of hydrogen/air mixtures. This results from the fact that the hydrogen/air mixture can ignite at local hot spots, for example at sharp edges of a piston crown of a piston in the internal combustion engine. This knocking combustion can have negative effects on the service life of the internal combustion engine or components of the internal combustion engine, such as the aforementioned piston. This needs to be improved.

### SUMMARY

Against this background, one task of the present invention is to provide an improved piston for a hydrogen-powered internal combustion engine.

Accordingly, a piston for a hydrogen-powered internal combustion engine is proposed. The piston comprises a piston head, a piston skirt connected to the piston head, and a combustion bowl provided on the piston head, wherein the piston has a piston diameter measurable on the piston skirt, wherein the combustion bowl has a minimum combustion bowl volume, the amount of which is 2.9674 times the amount of the piston diameter minus 220.68, and wherein the combustion bowl has a maximum combustion bowl volume, the amount of which is 4.1893 times the amount of the piston diameter minus 311.55.

By selecting the combustion bowl volume between the aforementioned minimum value and the aforementioned maximum value of the combustion bowl volume, it has surprisingly been shown that knocking combustion can be prevented. This significantly increases the service life of a hydrogen-powered internal combustion engine with such a piston or the service life of the piston itself. It also results in increased efficiency in the combustion of hydrogen.

The hydrogen-powered internal combustion engine can be an Otto engine. The hydrogen-powered internal combustion engine can comprise an engine block and several pistons housed in piston bores of the engine block. The piston can be referred to in particular as a hydrogen-powered piston or a hydrogen piston. This means in particular that in the present case, the terms “piston” and “hydrogen piston” can be used interchangeably.

In particular, the piston may be assigned a symmetry or center axis, around which the piston may be constructed in a substantially rotationally symmetrical manner. This aforementioned center axis can in particular be formed by a center axis of a cylinder which encloses surfaces of the piston skirt of the piston and has a minimum diameter, wherein the center axis of this cylinder is arranged perpendicular to a bolt hole of the piston, in particular to a center axis of the bolt hole.

The piston can also be assigned a coordinate system with a width direction or x-direction, a height direction or y-direction, and a depth direction or z-direction. The y-direction can also be referred to as the axial direction. The terms “y-direction” and “axial direction” are therefore interchangeable. The directions are oriented perpendicular to each other. The center axis coincides with the y-direction or is oriented parallel to the y-direction. The piston is also assigned a radial direction. The radial direction is oriented perpendicular to the center axis and points away from it.

The piston head and piston skirt can be two separate components that are joined together to form the piston. For example, the piston head and the piston skirt can be connected to each other in a material-locking manner. Material-locking connections are non-detachable connections that can only be separated from each other by destroying the connecting means and/or the connecting partners. Material-locking connections can be made, for example, by welding. For example, the piston head and the piston skirt are welded together.

The piston is preferably made of a metallic material. For example, the piston can be made of a light metal alloy, in particular an aluminum alloy. However, the piston can also be made of a steel alloy. Furthermore, the piston can also be made of cast iron.

The fact that the combustion bowl is “provided” on the piston head means in particular that the combustion bowl is incorporated into the piston head or arranged on the piston head. In particular, the combustion bowl is a depression incorporated into the piston head.

Preferably, the piston has a piston crown which surrounds the combustion bowl. The combustion bowl is set back with respect to an annular piston crown section of the piston crown which extends around the center axis. This means, in particular, that the combustion bowl is set back or recessed with respect to the piston crown section when viewed along the center axis or along the y-direction. The combustion bowl is open away from the piston skirt. The combustion bowl can be bounded away from the piston skirt in particular by a plane in which the piston crown section lies. This plane is oriented perpendicular to the center axis.

In this context, the term “amount” can be understood as the numerical value of any quantity, in particular detached from any unit of the quantity. The quantity can be a length or diameter, as well as an area or volume.

The piston diameter is defined in particular as the diameter of the smallest possible cylinder that encloses a piston skirt of the piston, i.e., skirt sections of the piston. This cylinder is oriented perpendicular to the center axis of the piston bolt hole. In particular, a first skirt section and a second skirt section are provided. The skirt sections together form the so-called piston skirt of the piston. The skirt sections can be connected to each other by means of wall sections. The piston diameter is preferably specified in millimeters (mm).

The combustion bowl volume is defined as the volume enclosed or enclosed by a combustion bowl surface of the combustion bowl and the aforementioned plane. The combustion bowl volume can be determined or calculated, for example, using a CAD (computer-aided design) model of the combustion bowl or the piston. In the simplest case, to determine the combustion bowl volume, the combustion bowl can be filled with water up to the afore-mentioned plane or up to the piston crown section, and the water contained in the combustion bowl can be poured into a measuring cup to determine the combustion bowl volume based on the volume of water read from the measuring cup.

The combustion bowl has the minimum combustion bowl volume, which is 2.9674 times the piston diameter minus a value of 220.68. At the same time, the combustion bowl has the maximum combustion bowl volume, which is 4.1893 times the piston diameter minus a value of 311.55. The combustion bowl volume is specified in cubic millimeters (mm³).

According to one embodiment, the combustion bowl has a combustion bowl volume which is limited by a minimum combustion bowl volume and a maximum combustion bowl volume, the values of which are dependent on the piston diameter, whereby the following ap-plies: minimum combustion bowl volume=2.9674 mm²*piston diameter−220.68 mm³, and maximum combustion bowl volume=4.1893 mm²*piston diameter−311.55 mm³.

Hereby, the value of the piston diameter reads in mm and the values of the minimum combustion bowl volume and the maximum combustion bowl volume read in mm³.

According to a further embodiment, a piston for a hydrogen-powered internal combustion engine is proposed. The piston comprises a piston head, a piston skirt connected to the piston head, and a combustion bowl provided on the piston head, wherein the piston has a piston diameter that can be measured on the piston skirt, wherein the combustion bowl has a combustion bowl volume that is limited by a minimum combustion bowl volume and a maximum combustion bowl volume, the amounts of which are each dependent on the piston diameter, wherein the following applies: minimum combustion bowl volume=2.9674 mm²*piston diameter−220.68 mm³, and maximum combustion bowl volume=4.1893 mm²*piston diameter −311.55 mm³.

According to a further embodiment, a piston for a hydrogen-powered internal combustion engine is proposed. The piston comprises a piston head, a piston skirt connected to the piston head, and a combustion bowl provided on the piston head, wherein the piston has a piston diameter measurable on the piston skirt, wherein the combustion bowl has a minimum combustion bowl volume that is 2.9674 times the piston diameter minus 220.68, and wherein the combustion bowl has a maximum combustion bowl volume that is 4.1893 times the piston diameter minus 311.55.

According to a further embodiment, the piston head has at least one valve pocket with a valve pocket volume, wherein the valve pocket volume is both part of (i.e., included in) the minimum combustion bowl volume and part of the maximum combustion bowl volume.

Several valve pockets may be provided. During operation of the internal combustion engine, valve tappets dip into the valve pockets. The valve pockets may be arranged evenly around the center axis. However, this is not absolutely necessary. The number of valve pockets preferably corresponds to the number of valves per piston. For example, four valve pockets are provided on the piston. Each valve pocket has a valve pocket volume, whereby the valve pocket volumes of all valve pockets are both part of the minimum combustion bowl volume and part of the maximum combustion bowl volume. Accordingly, the combustion bowl has a minimum combustion bowl volume that is 2.9674 times the piston diameter minus a value of 220.68. However, the valve pocket volumes of the valve pockets are part of the minimum combustion bowl volume. At the same time, the combustion bowl has a maximum combustion bowl volume that is 4.1893 times the piston diameter minus a value of 311.55. However, the valve pocket volumes of the valve pockets are part of the maximum combustion bowl volume. In this case, the combustion bowl volume is also specified in cubic milli-meters (mm³).

According to a further embodiment, the at least one valve pocket is provided on a fire bridge of the piston head.

The fire bridge preferably runs around the combustion bowl. The combustion bowl may be partially arranged within the fire bridge. In particular, the piston has a ring field. The ring field forms, in particular, a substantially cylindrical outer surface of the piston head, which may be constructed rotationally symmetrical to the center axis. The ring field may have several ring grooves arranged one above the other along the y-direction. The ring grooves are suitable for receiving piston rings. For example, two or three such ring grooves are provided. The fire bridge connects to the piston crown and is part of the ring field. However, the fire bridge does not have a ring groove as mentioned above for accommodating a piston ring. Viewed along the y-direction, the fire bridge ends at the piston crown section or at the plane closing off the combustion bowl at the top.

According to a further embodiment, the at least one valve pocket breaks through (e.g., extends through) the fire bridge along a radial direction of the piston.

Thus, the valve pocket interrupts the fire bridge, or the valve pockets interrupt the fire bridge. Viewed along the radial direction, the combustion bowl is thus opened toward an environment of the piston by the valve pocket or the valve pockets.

According to a further embodiment, the at least one valve pocket is ring-segment-shaped.

In this context, a “ring-segment” is to be understood as a section of a ring. Preferably, as mentioned above, several valve pockets are provided, which may be arranged at a distance from each other when viewed along a circumferential direction of the fire bridge.

According to a further embodiment, the piston has a ratio of a compression height to the piston diameter of 0.4 to 0.65.

The compression height is defined as the distance between the center axis of the bolt hole and an upper edge of the piston, namely the plane closing off the combustion bowl, or the piston crown section. The ratio of the compression height to the piston diameter is, in particular, 0.2 to 0.85, preferably 0.3 to 0.75, and more preferably 0.4 to 0.65. The compression height is preferably specified in millimeters (mm).

According to a further embodiment, the piston head has a cooling channel that runs (i.e., extends) completely around a center axis of the piston.

The cooling channel is preferably constructed to be rotationally symmetrical to the center axis. The cooling channel may in particular be torus-shaped. Cooling oil, in particular engine oil, can be fed through the cooling channel in order to dissipate heat introduced into the piston during operation. For this purpose, the cooling oil can be injected into the cooling channel with the aid of an injection nozzle arranged below the piston. The cooling channel can be introduced into the piston during its manufacture, for example with the aid of a flushable salt core. Alternatively, the cooling channel can also be introduced into the piston when subcomponents of the piston are joined together. With the aid of several bores, the cooling channel can be in fluid communication with an interior of the piston. Preferably, several bores are provided. For example, during operation of the piston, cooling oil can be injected into the interior with the aid of the aforementioned injection nozzle. At least part of the cooling oil enters the cooling channel through the holes and exits again. The cooling oil then dissipates heat from the piston.

According to a further embodiment, the combustion bowl extends along the center axis, at least up to the level of the cooling channel in the piston head.

This means, in particular, that the cooling channel and the combustion bowl can be arranged at least partially at the same height when viewed along the y-direction. In other words, the combustion bowl covers the cooling channel at least in sections when viewed along the radial direction.

According to a further embodiment, the combustion bowl has an edge-free combustion bowl surface.

The combustion bowl surface is preferably constructed to be rotationally symmetrical with respect to the center axis. The combustion bowl surface may have a substantially W-shaped geometry in cross-section. The W-shaped geometry may have a central section, a first wall section extending diagonally downward from the central section in the opposite direction to the y-direction, and a second wall section adjoining the first wall section and extending diagonally upward along the y-direction. The second wall section ends at the plane closing off the combustion bowl. In particular, the combustion bowl surface widens continuously from the central section along the y-direction. This means, in particular, that the diameter of the combustion bowl increases from the central section along the y-direction toward the plane. Thus, no cross-sectional constrictions, undercuts, steps, or the like are provided on the combustion bowl surface. The combustion bowl is thus edge-free or without edges. “Edge-free” or “without edges” can mean, in particular, that the combustion bowl surface has no edges. In particular, the central section and the wall sections of the combustion bowl surface merge into one another with roundings. In particular, the rounded edges have a radius greater than 1 millimeter (mm), preferably greater than 2 mm, more preferably greater than 3 mm, more preferably greater than 4 mm, and more preferably greater than 5 millimeters (mm). The edge-free combustion bowl surface prevents sharp edges in the area of the combustion bowl. Otherwise, sharp edges could cause local hot spots where the hydrogen/air mixture could ignite uncontrollably. However, this is reliably prevented by the edge-free combustion bowl surface.

Furthermore, a hydrogen-powered internal combustion engine with at least one such piston is proposed.

The hydrogen-powered internal combustion engine may be an Otto engine. The hydrogen-powered internal combustion engine may comprise an engine block and a plurality of pistons received in piston bores of the engine block. For example, the hydrogen-powered internal combustion engine may have three, four, five, six, or more than six pistons. The hydrogen-powered internal combustion engine may also be referred to as a hydrogen internal combustion engine. The terms “hydrogen-powered internal combustion engine” and “hydrogen internal combustion engine” may therefore be used interchangeably. In this context, “hydrogen-powered” means that the hydrogen-powered internal combustion engine burns gaseous hydrogen with the addition of atmospheric oxygen. The combustion of hydrogen converts chemical energy into mechanical work in the hydrogen-powered internal combustion engine.

The embodiments and features described for the proposed piston apply mutatis mutan-dis to the proposed hydrogen-powered internal combustion engine and vice versa.

“One” should not necessarily be understood as limiting the number of elements to exactly one. Rather, several elements, such as two, three, or more, may also be provided. Similarly, any other counting word used here should not be understood as limiting the number of elements to exactly the number specified. Rather, deviations in number are possible in either direction, unless otherwise specified.

Further possible implementations of the piston and/or the hydrogen-powered internal combustion engine also include combinations of features or embodiments described above or below with regard to the embodiments that are not explicitly mentioned. In doing so, the skilled person will also add individual aspects as improvements or additions to the respective basic form of the piston and/or the hydrogen-powered internal combustion engine.

Further advantageous designs and aspects of the piston and/or the hydrogen-powered internal combustion engine are the subject of the subclaims and the embodiments of the piston and/or the hydrogen-powered internal combustion engine described below. The piston and/or the hydrogen-powered internal combustion engine are explained in more detail below with reference to the accompanying figures, using preferred embodiments.

### BRIEF DESCRIPTION OF THE DRAWINGS

FIG. 1 shows a schematic side view of an embodiment of a vehicle;

FIG. 2 shows a schematic perspective view of an embodiment of a piston for an internal combustion engine of the vehicle according to FIG. 1;

FIG. 3 shows a schematic sectional view of the piston according to FIG. 2;

FIG. 4 shows another schematic sectional view of the piston according to FIG. 2;

FIG. 5 shows a schematic perspective view of another embodiment of a piston for an internal combustion engine of the vehicle according to FIG. 1;

FIG. 6 shows a schematic sectional view of the piston according to FIG. 5; and

FIG. 7 shows another schematic cross-sectional view of the piston according to FIG. 5.

### DETAILED DESCRIPTION

Unless otherwise specified, identical or functionally identical elements in the figures are marked with the same reference symbols.

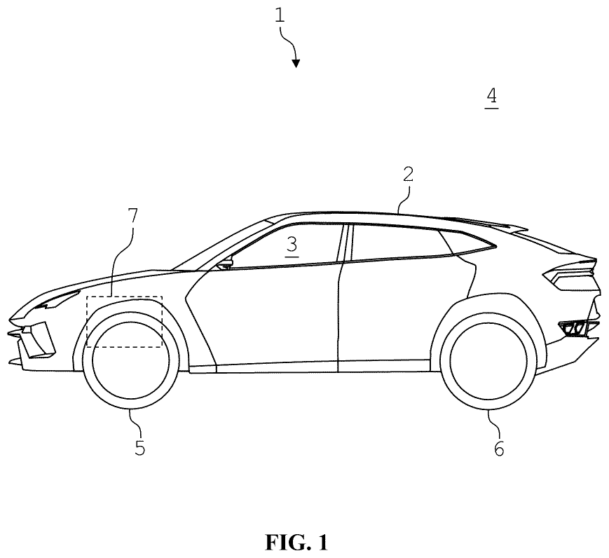

FIG. 1 shows a schematic side view of an embodiment of a vehicle 1. The vehicle 1 is a motor vehicle, in particular a passenger car. The vehicle 1 may also be a commercial vehicle, for example a truck, a harvester, or a construction machine. Furthermore, the vehicle 1 may also be a military vehicle. In addition, the vehicle 1 may also be an aircraft, a watercraft, or a rail vehicle. However, in the following, it is assumed that the vehicle 1 is a motor vehicle, in particular a passenger car.

The vehicle 1 comprises a body 2 which encloses a passenger compartment or vehicle interior 3 of the vehicle 1. A driver and passengers can be accommodated in the vehicle interior 3. The body 2 separates an environment 4 of the vehicle 1 from the vehicle interior 3. The vehicle interior 3 is accessible from the environment 4 by means of doors.

The vehicle 1 comprises a chassis with several wheels 5, 6. The number of wheels 5, 6 is essentially arbitrary. Preferably, the vehicle 1 has four wheels 5, 6. However, the vehicle 1 may have six wheels 5, 6, for example. The wheels 5, 6 are part of a chassis of the vehicle 1. Only two wheels 5, 6 may be driven. However, all wheels 5, 6 may also be driven. In this case, the vehicle 1 is an all-wheel drive vehicle.

The vehicle 1 comprises a combustion engine or internal combustion engine 7. The internal combustion engine 7 may be an Otto engine. The vehicle 1 may be powered solely by the internal combustion engine 7. However, the vehicle 1 may also be a hybrid vehicle. In this case, the vehicle 1 has at least one electric motor in addition to the internal combustion engine 7. The internal combustion engine 7 comprises an engine block and several pistons housed in piston bores in the engine block. For example, the internal combustion engine 7 may have three, four, five, six, or more than six pistons.

The internal combustion engine 7 is a hydrogen-powered internal combustion engine and can therefore also be referred to as such. The terms “internal combustion engine” and “hydrogen-powered internal combustion engine” can therefore be used interchangeably. In this case, “hydrogen-powered” means that the internal combustion engine 7 burns gaseous hydrogen with the addition of atmospheric oxygen. The combustion of the hydrogen converts chemical energy into mechanical work of the internal combustion engine 7.

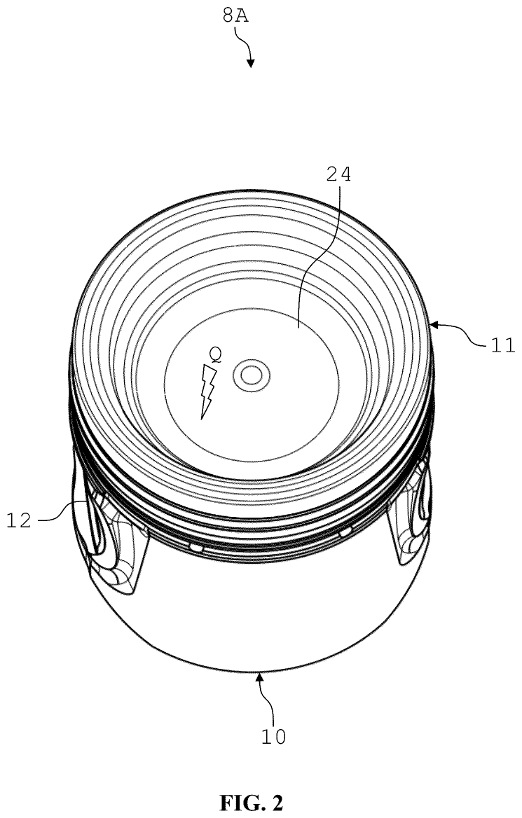

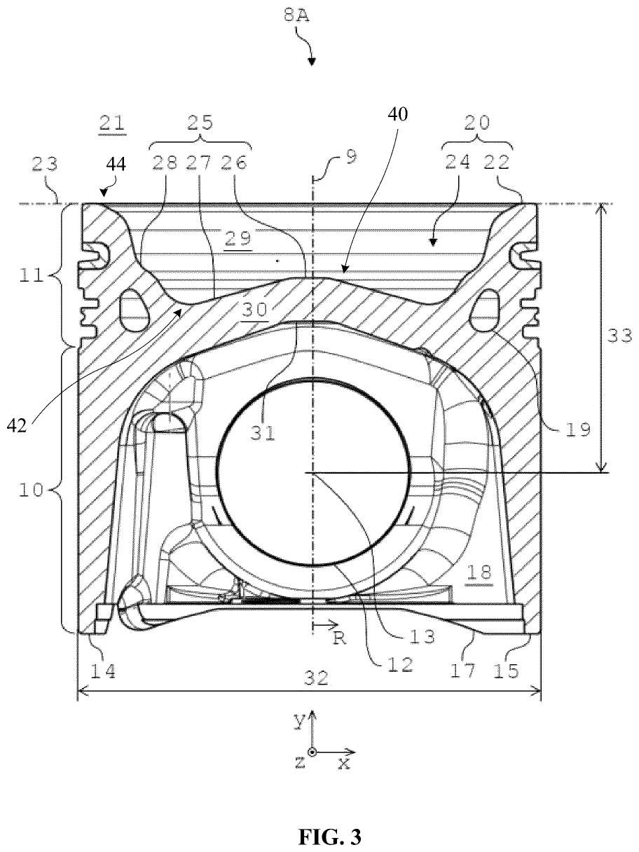

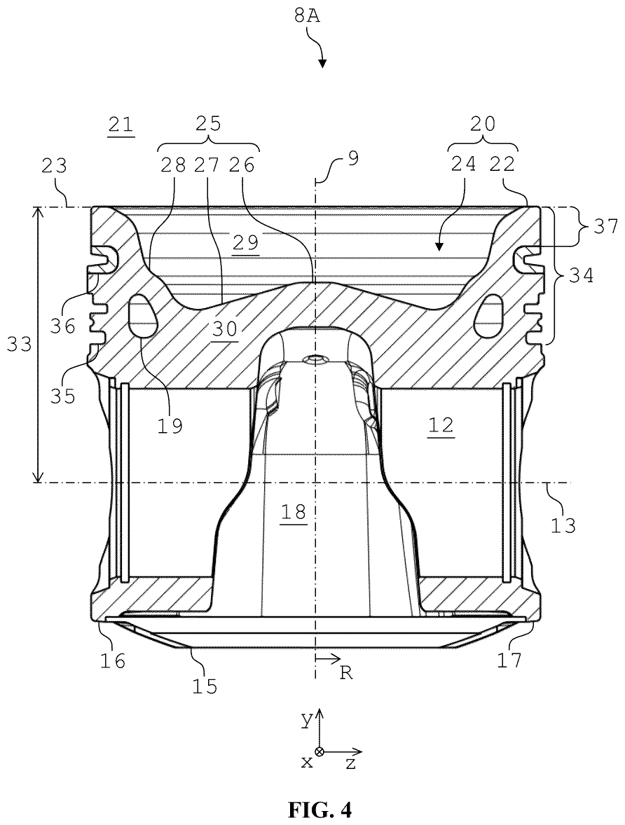

FIG. 2 shows a schematic perspective view of an embodiment of a piston 8A for the internal combustion engine 7. FIG. 3 shows a schematic sectional view of the piston 8A. FIG. 4 shows another (i.e., alternate) schematic sectional view of the piston 8A. Reference will now be made to FIGS. 2 to 4 simultaneously.

The piston 8A can be part of a vehicle 1 as described above, in particular the internal combustion engine 7. However, it is particularly preferred that the piston 8A be part of a commercial vehicle. In this case, the vehicle 1 is a commercial vehicle. The internal combustion engine 7 and thus the piston 8A can be used in any vehicles 1, ships, machines, or the like. Furthermore, the internal combustion engine 7 or the piston 8A can also be used for stationary applications, such as generators, power, heat, or the like.

The piston 8A is made of a metallic material. For example, the piston 8A can be made of a light metal alloy, in particular an aluminum alloy. However, the piston 8A can also be made of a steel alloy. Furthermore, the piston 8A can also be made of cast iron. The piston 8A can be composed of several sub-components that are connected to each other by a material bond. In material bonds, the connecting partners are held together by atomic or molecular forces. Material-locked connections are non-detachable connections that can only be separated from each other by destroying the connecting means and/or the connecting partners.

Material-locked connections can be made, for example, by gluing, soldering, or welding. For example, the aforementioned subcomponents of the piston 8A are welded together, in particular friction welded.

The piston 8A may comprise a symmetry or center axis 9, about which the piston 8A may be constructed to be essentially rotationally symmetrical. The piston 8A is assigned a co-ordinate system with a width direction or x-direction x, a height direction or y-direction y, and a depth direction or z-direction z. The y-direction y can also be referred to as the axial direction. The terms “y-direction” and “axial direction” are therefore interchangeable. The x, y, and z directions are oriented perpendicular to each other. The center axis 9 corresponds in particular to the y-direction y or is oriented parallel to it. The piston 8A is also assigned a radial direction R. The radial direction R is oriented perpendicular to the center axis 9 and points away from it.

The piston 8A has a piston foot or piston skirt 10 and a piston head 11. Viewed along the center axis 9, the piston skirt 10 is located below the piston head 11. The piston skirt 10 has a piston hub with a bolt hole 12, in which a bolt (not shown) can be inserted to connect the piston 8A to a connecting rod (not shown) of the internal combustion engine 7. A symmetry or center axis 13 of the bolt hole 12 intersects the center axis 9 or is offset from it. Furthermore, the center axis 13 is oriented perpendicular to the center axis 9. The center axis 13 coincides with the z-direction z or is oriented parallel to it.

In the orientation shown in FIG. 3, a skirt section 14, 15 is provided on each side of the bolt hole 12. A first skirt section 14 and a second skirt section 15 are provided. The skirt sections 14, 15 can be designed to be cylindrical in sections. In other words, the skirt sections 14, 15 can form part of a cylinder that is constructed rotationally symmetrical to the center axis 9. The skirt sections 14, 15 together form a so-called piston skirt of the piston 8A. The skirt sections 14, 15 may be constructed in sections that are rotationally symmetrical with respect to the center axis 9. However, the skirt sections 14, 15 do not form a complete cylinder. One of the skirt sections 14, 15 forms a pressure side of the piston 8A, while the other of the skirt sections 14, 15 forms a counterpressure side of the piston 8A.

The skirt sections 14, 15 are connected to each other by means of wall sections 16, 17. A first wall section 16 and a second wall section 17 are provided. The radial direction R points away from the center axis 9 in the direction of the skirt sections 14, 15 towards the outside. The bolt hole 12 passes through the wall sections 16, 17. The skirt sections 14, 15 and the wall sections 16, 17 enclose an interior 18 of the piston skirt 10. The interior 18 is open at the bottom in the orientation of FIGS. 2 to 4. The aforementioned bolt for coupling the piston 8A to the connecting rod runs along the center axis 13 through the interior 18.

The piston 8A has a cooling channel 19 that runs completely around the center axis 9 and is preferably constructed to be rotationally symmetrical to it. The cooling channel 19 is in particular torus-shaped. Cooling oil, in particular engine oil, can be fed through the cooling channel 19 in order to dissipate heat Q introduced into the piston 8A during operation. For this purpose, the cooling oil can be injected into the cooling channel 19 by means of an injection nozzle arranged below the piston 8A in the orientation shown in FIGS. 2 to 4. The cooling channel 19 can be introduced into the piston 8A during its manufacture, for example with the aid of a flushable salt core. Alternatively, the cooling channel 19 can also be introduced into the piston 8A when the aforementioned sub-components of the piston 8A are connected to one another.

With the aid of several bores (not shown), the cooling channel 19 can be in fluid communication with the interior 18. The number of bores is essentially arbitrary. Preferably, several bores are provided, which can be arranged evenly around the center axis 9. The bores can also be arranged unevenly around the center axis 9. For example, during operation of the piston 8A in the orientation shown in FIGS. 2 to 4, cooling oil can be injected into the interior 18 from below with the aid of the aforementioned injection nozzle. At least part of the cooling oil enters the cooling channel 19 through the holes and exits again. The cooling oil then dissipates heat Q from the piston 8A.

The piston head 11 has a piston crown 20 which faces a cylinder head of the internal combustion engine 7. Most of the heat Q is also introduced into the piston crown 20. The piston crown 20 faces in particular a combustion chamber 21 of the internal combustion engine 7. The piston crown 20 comprises an annular piston crown section 22, which spans a plane 23 oriented perpendicular to the center axis 9.

Furthermore, the piston crown 20 has a combustion bowl 24 which is set back relative to the piston crown section 22. Viewed along the center axis 9 or along the y-direction y, the combustion bowl 24 is thus offset or recessed relative to the piston crown section 22. In the orientation of FIGS. 3 and 4, the combustion bowl 24 is bounded at (i.e., is in part defined by) the top by the plane 23. Viewed along the center axis 9, the combustion bowl 24 extends at least to the level of the cooling channel 19.

The combustion bowl 24 has (i.e., is in part defined by) a combustion bowl surface 25, which can have any geometry. The combustion bowl surface 25 is constructed to be rotationally symmetrical with respect to the center axis 9. In cross-section, the combustion bowl surface 25 essentially has a W-shaped geometry with a central section 26, a first wall section 27 extending obliquely downward from the central section 26 in the opposite direction to the y-direction y, and a second wall section 28 adjoining the first wall section 27 and extending obliquely upward along the y-direction y. The second wall section 28 ends at the plane 23.

The combustion bowl surface 25 widens continuously from the central section 26 along the y-direction y (i.e., extends radially outward from the center axis 9 to the fire bridge 37). This means, in particular, that the diameter of the combustion bowl 24 increases from the central section 26 along the y-direction y toward the plane 23. Thus, no cross-sectional constrictions, undercuts, steps, or the like are provided on the combustion bowl surface 25. The combustion bowl surface 25 is thus edge-free or without edges. In particular, the central section 26 and the wall sections 27, 28 merge into one another with roundings. As shown in FIG. 3, the first wall section 27 merges with the central section 26 at a first rounded edge 40, the second wall section 28 merges with the first wall section 27 at a second rounded edge 42 and merges with the annular piston crown 22 at a third rounded edge 44.

The combustion bowl 24 is open at the top in the orientation shown in FIGS. 2 to 4.

The combustion bowl 24 has a combustion bowl volume 29. The combustion bowl volume 29 is defined as a volume enclosed or enclosed by the combustion bowl surface 25 and the plane 23. The combustion bowl volume 29 can be determined or calculated, for example, using a CAD (computer-aided design) model of the combustion bowl 24.

In the simplest case, to determine the combustion bowl volume 29, the combustion bowl 24 can be filled with water up to the plane 23 or up to the piston crown section 22, and the water collected in the combustion bowl 24 can be poured into a measuring cup in order to determine the combustion bowl volume 29 based on the volume of water read from the measuring cup.

A wall 30 separates the combustion bowl 24 from the interior 18. The wall 30 forms part of the combustion bowl surface 25 at the front. At the rear, i.e. facing the interior 18, the wall 30 forms a so-called inner shape 31 of the piston 8A. The inner shape 31 can be cone-shaped or conical.

The piston 8A has a piston diameter 32. The piston diameter 32 is defined as the diameter of the smallest possible cylinder that encloses the piston skirt, i.e., the skirt sections 14, 15. This cylinder is oriented perpendicular to the center axis 13. The combustion bowl 24 preferably has a minimum combustion bowl volume 29 that is 2.9674 times the piston diameter 32 minus a value of 220.68. At the same time, the combustion bowl 24 has a maximum combustion bowl volume 29 that is 4.1893 times the piston diameter 32 minus a value of 311.55 (i.e., the combustion bowl volume 29 is configured to have between a minimum combustion bowl volume which is 2.9674 times the piston diameter minus a value of 220.68, and a maximum combustion bowl volume which is 4.1893 times the piston diameter minus a value of 311.55). The combustion bowl volume 29 is specified in cubic millimeters (mm³).

Furthermore, the piston 8A has a compression height 33. The compression height 33 is defined as the distance between the center axis 13 and an upper edge of the piston 8A, namely the plane 23 or the piston crown section 22. The ratio of the compression height 33 to the piston diameter 32 is in particular 0.2 to 0.85, preferably 0.3 to 0.75, and more preferably 0.4 to 0.65.

A ring section or ring field 34 is provided on the piston head 11. The ring field 34 forms, in particular, a substantially cylindrical outer surface of the piston head 11, which can be constructed rotationally symmetrical to the center axis 9. The ring field 34 has several ring grooves 35 arranged one above the other along the y-direction y, of which only one is provided with a reference mark in FIG. 4. The ring grooves 35 are suitable for receiving piston rings. For example, two or three such ring grooves 35 are provided.

Furthermore, the ring field 34 may also have a ring carrier 36. The ring carrier 36 runs completely around the center axis 9. In cross-section, the ring carrier 36 may be U-shaped. The ring carrier 36 can accommodate or carry a piston ring as mentioned above. The ring carrier 36 can be made of a different material than the piston head 11 or the piston 8A. For example, the ring carrier 36 can be made of a steel alloy, whereas the piston 8A can be made of an aluminum alloy. In this case, the ring carrier 36 can be an insert to which the piston 8A is cast in a casting process.

A fire bridge 37 adjoining the piston crown section 22 is part of the ring field 34. However, the fire bridge 37 does not have the aforementioned ring groove 35 for receiving a piston ring. Viewed along the y-direction y, the fire bridge 37 ends at the piston crown section 22 or at the plane 23. In the FIGS. 3 and 4 example, the fire bridge 37 includes an upper surface positioned on the plane 23 oriented perpendicular to the center axis 9.

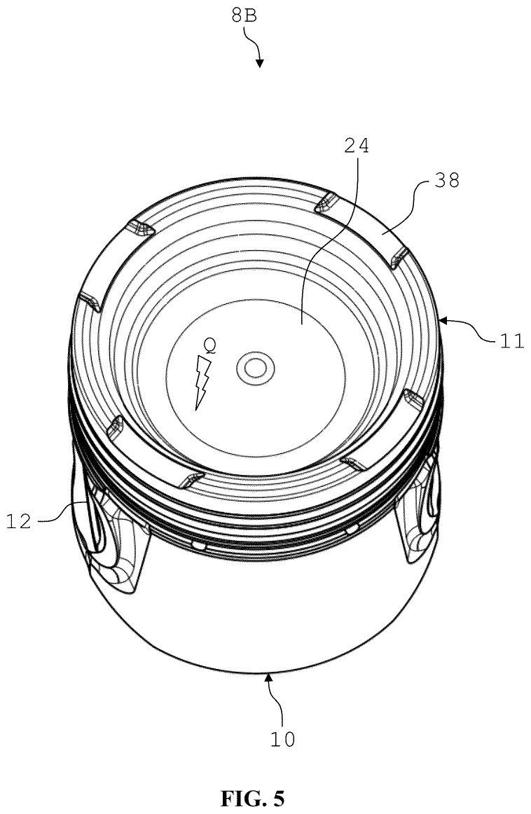

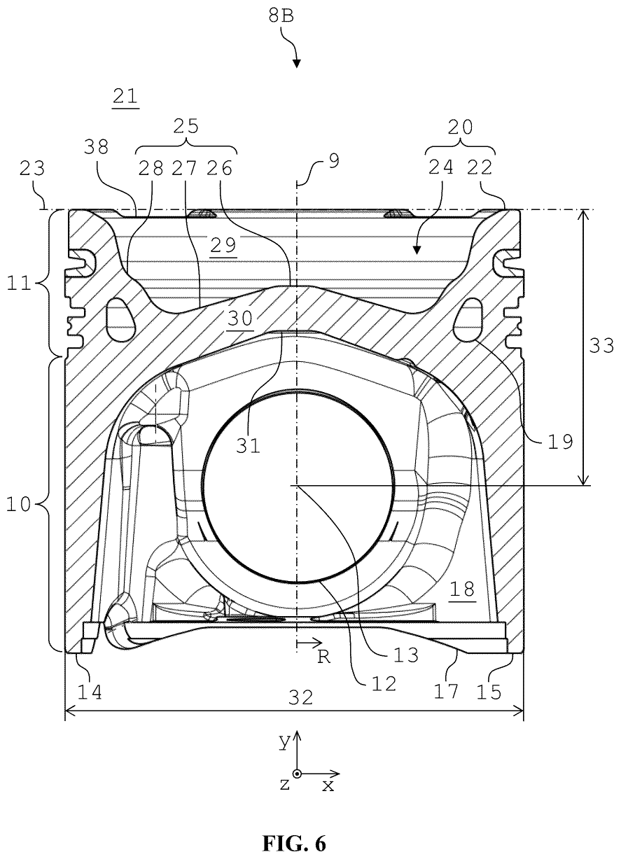

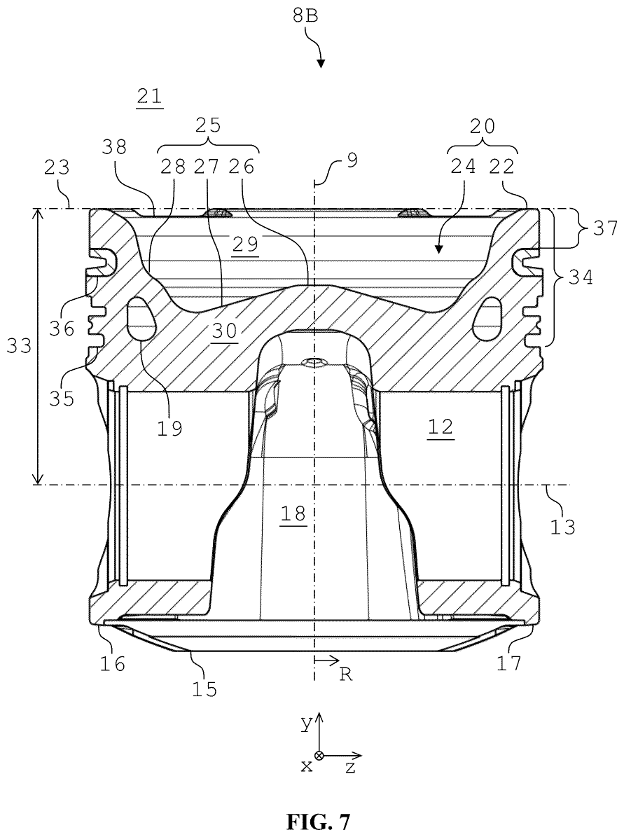

FIG. 5 shows a schematic perspective view of another embodiment of a piston 8B for the internal combustion engine 7. FIG. 6 shows a schematic sectional view of the piston 8B. FIG. 7 shows another (i.e., alternate) schematic sectional view of the piston 8B. Reference will now be made to FIGS. 5 to 7 simultaneously.

The design of the piston 8B is essentially the same as that of the piston 8A. Therefore, only the differences between the piston 8B and the piston 8A will be discussed below. All statements regarding the piston 8A apply to the piston 8B and vice versa.

Unlike the piston 8A, the piston 8B has several valve pockets 38, only one of which is marked with a reference number in FIGS. 5 to 7. Valve tappets dip into the valve pockets 38 during operation of the internal combustion engine 7. The valve pockets 38 may be arranged evenly around the center axis 9. However, this is not absolutely necessary. The number of valve pockets 38 preferably corresponds to the number of valves per piston 8B. For example, four valve pockets 38 are provided.

The valve pockets 38 are preferably provided on the fire bridge 37. The valve pockets 38 penetrate the fire bridge 37 along the radial direction R of the piston 8B. The valve pockets 38 are preferably ring-segment-shaped.

Each valve pocket 38 has a valve pocket volume, whereby the valve pocket volumes of the valve pockets 38 are both part of the minimum combustion bowl volume 29 and part of the maximum combustion bowl volume 29. Accordingly, the combustion bowl 24 of the piston 8B also has a minimum combustion bowl volume 29, which is 2.9674 times the piston diameter 32 minus a value of 220.68. However, the valve pocket volumes of the valve pockets 38 are part of the minimum combustion bowl volume 29.

At the same time, the combustion bowl 24 of the piston 8B also has a maximum combustion bowl volume 29 that is 4.1893 times the piston diameter 32 minus a value of 311.55. However, the valve pocket volumes of the valve pockets 38 are part of the maximum combustion bowl volume 29. The combustion bowl volume 29 is specified in cubic millimeters (mm³).

A total valve pocket volume of all the valve pockets 38 can be defined here as the difference in volume between a piston blank, which is identical in structure to the piston 8B except for the valve pockets 38 and does not yet have any valve pockets 38, and the piston 8B itself, which already has the valve pockets 38. The valve pockets 38 can be milled into the piston blank or molded onto a casting mold that can be used to manufacture the piston blank.

Although the present invention has been described with reference to embodiments, it is capable of numerous modifications.

### REFERENCES

1 vehicle
2 body
3 vehicle interior
4 environment
5 wheel
6 wheel
7 internal combustion engine
8A piston
8B piston
9 center axis
10 piston skirt
11 piston head
12 bolt hole
13 center axis
14 skirt section
15 skirt section
16 wall section
17 wall section
18 interior
19 cooling channel
20 piston crown
21 combustion chamber
22 piston crown section
23 plane
24 combustion bowl
25 combustion bowl surface
26 central section
27 wall section
28 wall section
29 combustion bowl volume
30 wall
31 inner shape
32 piston diameter
33 compression height
34 ring field
35 ring groove
36 ring carrier
37 fire bridge
38 valve pocket
40 first rounded edge
42 second rounded edge
44 third rounded edge
Q heat
R radial direction
X x-direction
y y-direction
Z z-direction

1. A piston for a hydrogen-powered internal combustion engine comprising:
a piston head;
a piston skirt connected to the piston head ; and
a combustion bowl provided on the piston head;
wherein the piston has a piston diameter measured on the piston skirt,
wherein the combustion bowl has a minimum combustion bowl volume which is 2.9674 times the piston diameter minus a value of 220.68, and
wherein the combustion bowl has a maximum combustion bowl volume which is 4.1893 times the piston diameter minus a value of 311.55.

2. The piston of claim 1, wherein the piston head has at least one valve pocket having a valve pocket volume, wherein the valve pocket volume is included in the minimum combustion bowl volume and the maximum combustion bowl volume.

3. The piston of claim 2, wherein the at least one valve pocket is provided on a fire bridge of the piston head.

4. The piston of claim 3, wherein the at least one valve pocket extends through the fire bridge viewed along a radial direction of the piston.

5. The piston of claim 3, wherein the at least one valve pocket is ring-segment-shaped.

6. The piston of claim 1, wherein the piston has a ratio of a compression height to the piston diameter of 0.4 to 0.65.

7. The piston of claim 1, wherein the piston head has a cooling channel that extends completely around a center axis of the piston.

8. The piston of claim 7, wherein the combustion bowl extends into the piston head along the center axis at least to a level of the cooling channel.

9. The piston of claim 1, wherein the combustion bowl has an edge-free combustion bowl surface.

10. A hydrogen-powered internal combustion engine comprising at least one of the piston of claim 1.

11. The piston of claim 4, wherein the at least one valve pocket is ring-segment-shaped.

12. The piston of claim 3, wherein the piston has a ratio of a compression height to the piston diameter of 0.4 to 0.65.

13. The piston of claim 6, wherein the piston head has a cooling channel that extends completely around a center axis of the piston.

14. The piston of claim 8, wherein the combustion bowl has an edge-free combustion bowl surface.

15. A piston for use in a hydrogen-powered internal combustion engine, comprising:
a piston head comprising:
a center axis;
a fire bridge having an upper surface positioned on a plane oriented perpendicular to the center axis; and
a combustion bowl defined by the plane and an edge-free combustion bowl surface extending radially outward from the center axis to the fire bridge at the upper surface; and
a piston skirt connected to the piston head, the piston having a piston diameter measured on the piston skirt,
wherein the combustion bowl has a combustion bowl volume configured to have between a minimum combustion bowl volume which is 2.9674 times the piston diameter minus a value of 220.68, and a maximum combustion bowl volume which is 4.1893 times the piston diameter minus a value of 311.55.

16. The piston of claim 15, wherein the edge-free combustion bowl surface comprises:
a central section;
a first wall section merging with the central section at a first rounded edge; and
a second wall section merging with the first wall section at a second rounded edge and merging with the fire bridge at a third rounded edge, wherein the first rounded edge, the second rounded edge, and the third rounded edge each comprise a radius greater than 1 millimeter (mm).

17. The piston of claim 16, wherein the radius of first rounded edge, the second rounded edge, and the third rounded edge is greater than 5 millimeters (mm).

18. The piston of claim 15, wherein the piston head defines a valve pocket positioned in the fire bridge and extending downward from the plane and parallel to the center axis, the valve pocket having a valve pocket volume, wherein the valve pocket volume is included in the minimum combustion bowl volume and the maximum combustion bowl volume.

19. The piston of claim 15, wherein the piston has a ratio of a compression height to the piston diameter of 0.4 to 0.65.
